(19) United States
(12) Patent Application Publication
(10) Pub. No.: US 2012/0043885 A1
(43) Pub. Date: Feb. 23, 2012

(54) LED LAMP WITH CIRCLING LED MODULES AND ENCAPSULATION

(75) Inventor: CHIH-MING LAI, Chu-Nan (TW)

(73) Assignee: FOXSEMICON INTEGRATED TECHNOLOGY, INC., Chu-Nan (TW)

(21) Appl. No.: 12/903,122

(22) Filed: Oct. 12, 2010

(30) Foreign Application Priority Data
Aug. 19, 2010 (TW) 99127656

(51) Int. Cl. H01J 13/46

(52) U.S. Cl. 315/35

(57) ABSTRACT

An LED lamp includes at least one LED module, an electrical sleeve configured for electrically connecting with a bulb socket, a heat dissipation element, and an encapsulation covering the at least one LED module. The heat dissipation element is arranged with one end connected to the electrical sleeve and the opposite end exposed. The at least one LED module and the encapsulation encircle the heat dissipation element.

### BACKGROUND

1. Technical Field

The present disclosure generally relates to LED lamps, and particularly to a LED lamp with an encircled LED modules and encapsulation

2. Description of the Related Art

Light emitting diodes (LEDs) have many advantages, such as high luminosity, low operational voltage, low power consumption, compatibility with integrated circuits, easy driving, long-term reliability, and environmental friendliness. All of these reasons have promoted the LEDs as a widely used light source. Light emitting diodes are commonly applied in lighting applications.

LED illumination apparatuses must overcome heat dissipation challenges. An LED lamp is commonly arranged with LED lighting module on the top and heat dissipation element at the periphery. The heat dissipation efficiency of LED lamp is limited. This will reduce the lifespan of the LED lamp. Also, the LED lamp will be too hot to touch during disconnection. This adds to the inconvenience of using the LED lamp.

What is needed, therefore, is an LED lamp, which can improve heat dissipation efficiency and convenience of using the lamp, and ameliorate the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the LED lamp. Moreover, in the drawings, like reference numerals designate corresponding parts throughout the views.

FIG. 1 is a schematic cross section of an LED lamp in accordance with a first embodiment.

FIG. 2 is a schematic cross section of an LED lamp in accordance with a second embodiment.

FIG. 3 is a schematic cross section of an LED lamp in accordance with a third embodiment.

FIG. 4 is a schematic cross section of an LED lamp in accordance with a fourth embodiment.

FIGS. 5-7 are schematic front views of heat dissipation elements.

FIG. 8 is a schematic cross section of an LED lamp in accordance with a fifth embodiment.

### DETAILED DESCRIPTION

Embodiments of an LED lamp as disclosed are described in detail here with reference to the drawings.

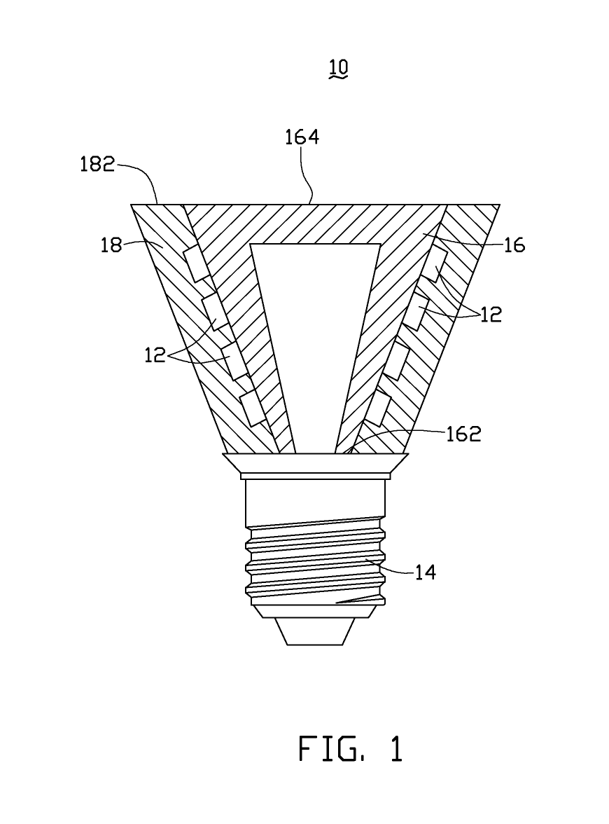

Referring to FIG. 1, an LED lamp 10 in accordance with a first embodiment includes at least one LED module 12, an electrical sleeve 14, a heat dissipation element 16, and an encapsulation 18. The at least one LED module 12 is arranged evenly on the surface of the heat dissipation element 16 for thermally conducting the heat from the at least one LED module 12 to the heat dissipation element 16. The heat dissipation element 16 includes one fixable end 162 for fixing to the electrical sleeve 14 and one heat dissipation end 164 opposite to the fixable end 162 and exposed to air.

In this embodiment, the heat dissipation end 164 is planar and is at the top portion of the LED lamp 10, and the heat dissipation element 16 is an inverted trapezoidal hollow body. The heat dissipation element 16 can be Cu, Sn, Al, Au, Ag, Mo, W, Mg, or an alloy thereof, or ceramic material such as AlO, AlN, or BeO. The heat dissipation element 16 can also be high radiant material, such as Alumite, with emissivity exceeding 0.7. The electrical sleeve 14 connects to an electrical connection base (not shown), for example, a bulb socket, for power supply. The electrical sleeve 14 can be E14, E17, E26, E27, GU10, PAR30, or MR16 type.

The encapsulation 18 encircles the at least one LED module 12 on the heat dissipation element 16 and covers a part of the heat dissipation element 16. The encapsulation 18 connects to the electrical sleeve 14 near the fixable end 164 of the heat dissipation element 16. The encapsulation 18 includes a top end 182 opposite to the electrical sleeve 14. The top end 182 is a plane and coplanar with the heat dissipating end 164 of the heat dissipation element 16. The encapsulation 18 can be resin, epoxy, silicone, polycarbonate (PC), noryl, polybutylene terephthalate (PBT), polyphthalamide (PPA), polypropylene (PP), polymethyl methacrylate (PMMA), glass fiber, TiO₂, CaCO₃, or a combination thereof. The encapsulation 18 is not thermal conductive so that the temperature of the encapsulation 18 will be lower than that of the heat dissipation element 16.

The at least one LED module 12 is electrically connected to the electrical sleeve 14 through a circuit board (not shown) for supplying power. Thus, the electrical conductive path and the thermal conductive path of the LED lamp 10 are separated. The encapsulation 18, which is not thermal conductive will be the main contact (gripping) part of the LED lamp when disconnecting the LED lamp from the power supply. The heat dissipating end 164 of the heat dissipation element 16 is exposed to air for heat dissipation.

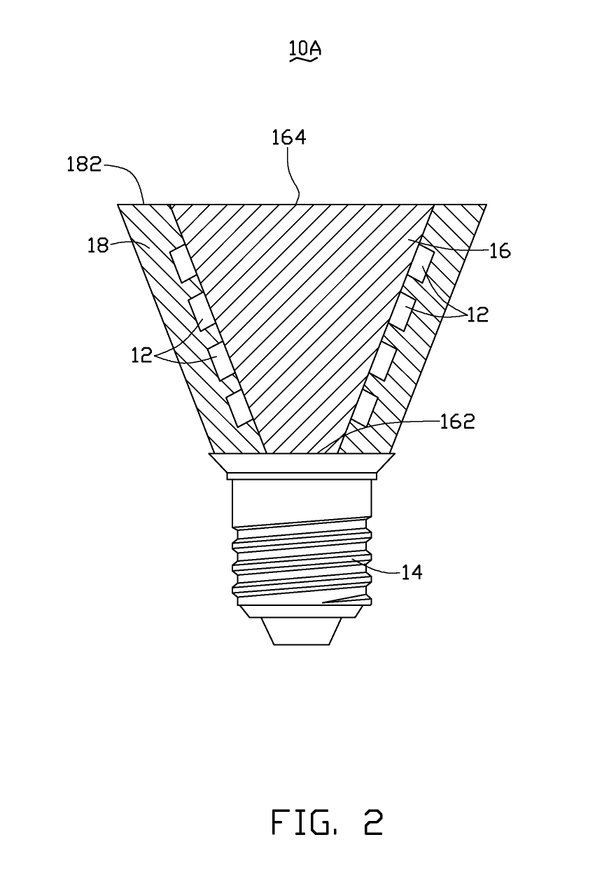

Referring to FIG. 2, an LED lamp 10A in accordance with a second embodiment includes at least one LED module 12, an electrical sleeve 14, a heat dissipation element 16, and an encapsulation 18. The only difference from the LED lamp 10 of FIG. 1 is that the heat dissipation element 16 is an inverted trapezoidal solid body for improving heat dissipation efficiency. The heat dissipation element 16 of FIG. 1 is hollow for reducing a weight thereof.

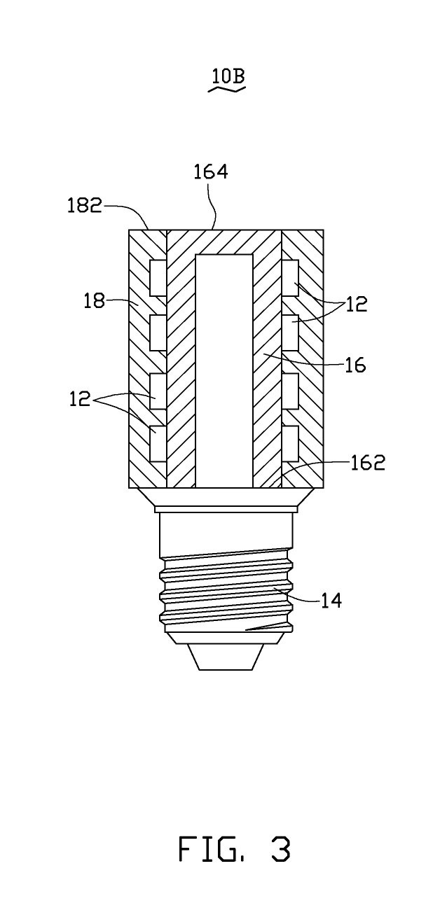

Referring to FIG. 3, an LED lamp 10B in accordance with a third embodiment includes at least one LED module 12, an electrical sleeve 14, a heat dissipation element 16, and an encapsulation 18. The only difference from the LED lamp 10 of FIG. 1 is that the heat dissipation element 16 is a rectangular hollow body.

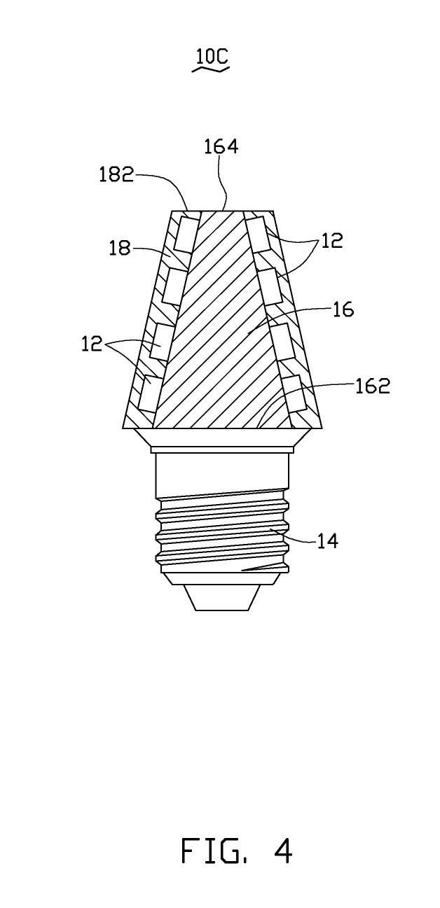

Referring to FIG. 4, an LED lamp 10C in accordance with a fourth embodiment includes at least one LED module 12, an electrical sleeve 14, a heat dissipation element 16, and an encapsulation 18. The only difference from the LED lamp 10 of FIG. 1 is that the heat dissipation element 16 is a trapezoidal solid body.

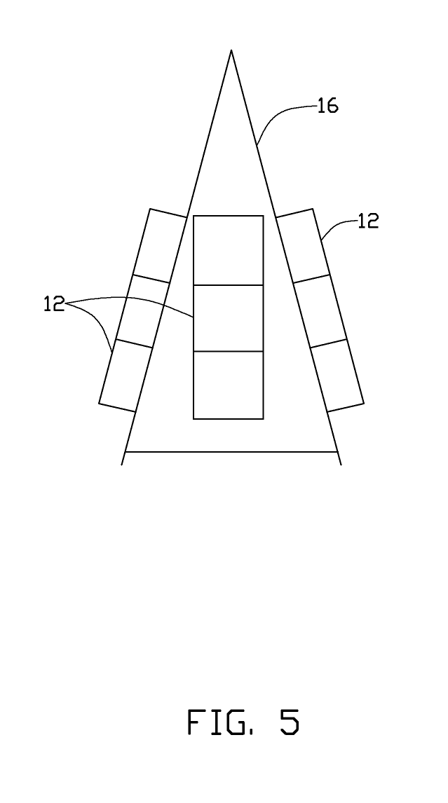

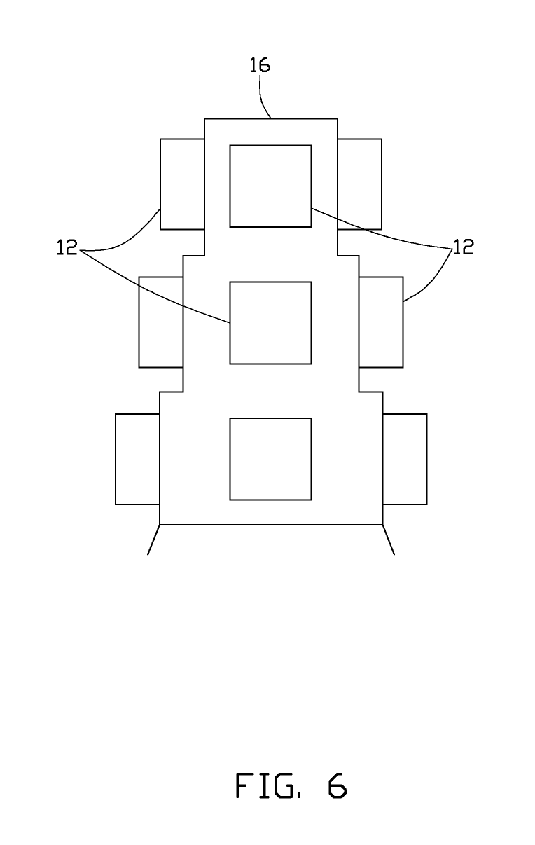

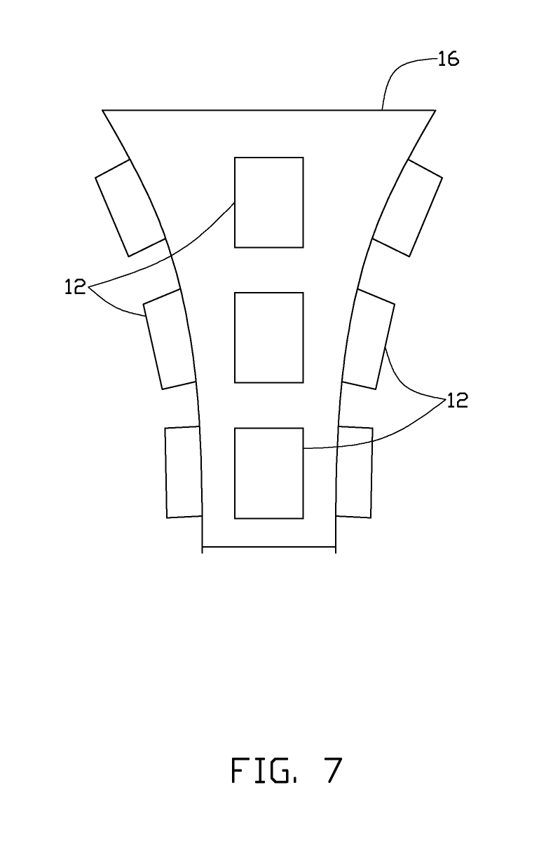

FIGS. 5-7 are schematic front views of heat dissipation elements. The heat dissipation element 16 is a conical body with the at least one LED module 12 arranged in column in FIG. 5. The heat dissipation element 16 is a stepped cylinder in FIG. 6. The heat dissipation element 16 is a funnel with curved surface in FIG. 7. The heat dissipation element 16 can be polyhedron with multiple LED modules 12 arranged symmetrically thereon.

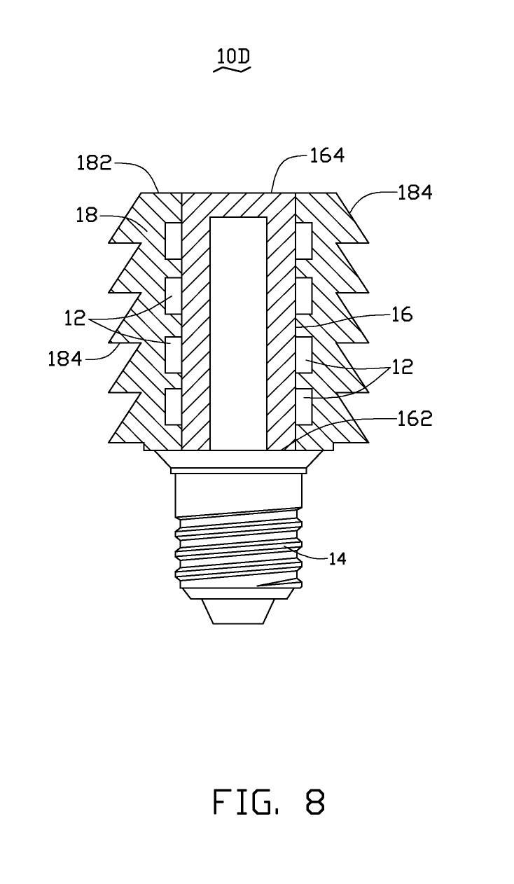

Referring to FIG. 8, an LED lamp 10D in accordance with a fifth embodiment includes at least one LED module 12, an electrical sleeve 14, a heat dissipation element 16, and an encapsulation 18. The only difference from the LED lamp 10 of FIG. 1 is that the encapsulation 18 further includes a reflection or refraction element 184. The reflection or refraction element 184 can be at the outer surface or inner surface of the encapsulation 18. In this embodiment, the reflection or refraction element 184 is at the outer surface of the encapsulation 18.

It is to be understood, however, that even though numerous characteristics and advantages of the disclosure have been set forth in the foregoing description, together with details of the structures and functions of the embodiment(s), the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp comprising at least one LED module, an electrical sleeve configured for electrically connecting with a power source, a heat dissipation element, and an encapsulation covering the at least one LED module, wherein the heat dissipation element is arranged with one end connecting to the electrical sleeve and an opposite end exposing to air, and the at least one LED module and the encapsulation are circling around the heat dissipation element, heat generated by the at least one LED module is dissipated to the air through the opposite end of the heat dissipation element.

2. The LED lamp of claim 1, wherein the at least one LED module is electrically connecting to the electrical sleeve with a circuit board.

3. The LED lamp of claim 1, wherein the at least one LED module is multiple and arranged symmetrically.

4. The LED lamp of claim 1, wherein the opposite end of the heat dissipation element is a plane.

5. The LED lamp of claim 1, wherein the heat dissipation element is a polyhedron.

6. The LED lamp of claim 5, wherein the polyhedron is inverted trapezoidal, trapezoidal, cylindrical, stepped cylindrical, conical, or curved trapezoidal.

7. The LED lamp of claim 5, wherein the polyhedron is a hollow body or a solid body.

8. The LED lamp of claim 1, wherein the one end of the encapsulation opposite to the electrical sleeve is a plane.

9. The LED lamp of claim 8, wherein the plane is at the same plane with the plane of the opposite end of the heat dissipation element.

10. The LED lamp of claim 1, wherein the encapsulation includes a reflection or refraction element.

11. The LED lamp of claim 1, wherein the electrical sleeve is configured for electrically connecting with a bulb socket.

12. The LED lamp of claim 11, wherein the electrical sleeve is one of following types: E14, E17, E26, E27, GU10, PAR30, and MR16.
